(19) United States
(12) Patent Application Publication
(10) Pub. No.: US 2008/0049863 A1
(43) Pub. Date: Feb. 28, 2008

(54) Apparatus, method and computer program product providing soft decision generation with lattice reduction aided MIMO detection

(75) Inventor: Juha Heiskala, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/511,927

(22) Filed: Aug. 28, 2006

(51) Int. Cl. H04L 1/02

(52) U.S. Cl. 375/267

(57) ABSTRACT

A circuit that includes an input for coupling to a MIMO signal received from a channel to compute a change of basis matrix T and a reduced lattice basis matrix HT, to form a list L of points used for soft decision calculation using columns of the matrix HT and to perform MIMO detection for each point in the list L. The circuit further includes an output to output a list C of constellation points to a unit for use in to calculating soft bit decisions. The list L may include a received point r and a set of points that are formed by adding to the point r a column of the matrix HT multiplied by +1, −1, +i, or −i, or it may be formed by performing hard MIMO detection for the received point r, and adding the columns of HT to the to the hard decision point, or it may be formed by using a hard decision estimate of transmitted vector x and adding multiplied columns of the matrix T to the vector x.

### TECHNICAL FIELD

The teachings in accordance with the exemplary embodiments of this invention relate generally to multiple antenna receivers, such as those used in Multiple Input, Multiple Output wireless communication systems, receivers, detectors, method and computer program products and, more specifically, relate to lattice reduction techniques used in Multiple Input, Multiple Output wireless communication systems.

### BACKGROUND

The following abbreviations are herewith defined:

MIMO Multiple Input Multiple Output

OFDM Orthogonal Frequency Division Multiplexing

H MIMO channel matrix

LLL Lenstra-Lenstra-Lovasz lattice reduction algorithm

LR Lattice Reduction

T unimodular integer change of lattice basis matrix

BER Bit Error Rate

SNR Signal to Noise Ratio

QPSK Quadrature Phase Shift Keying

QAM Quadrature Amplitude Modulation

SIC Serial Interference Cancellation

MMSE Minimum Mean Square Error

Lattice reduction-aided MIMO detectors presented in the literature typically produce only hard decision estimates of the transmitted bits. This implies that there is no reliability or soft information generated for the hard bit estimates. The lack of soft information results in a substantial loss of performance for modem error correcting codes. Good quality soft information output from the MIMO detector is crucial for good overall performance of the receiver. Hence, to make lattice reduction-based MIMO detectors usable in practice good quality soft information should be generated by the lattice reduction based MIMO detector.

In one publication (University of Oulu Centre for Wireless Communications project “MIMO Techniques for 3G Standard and System Evolution” report titled “MIMO detector algorithm and architecture development”, (Aug. 31, 2005)) there is presented a soft decision generation method for lattice reduction-based detectors. However, a problem with the presented approach is that it requires the calculation of all of the possible points T⁻¹x, where T is a change of basis matrix for a channel H, and where x is the transmitted symbol vector. In practice, this approach would prove to be infeasible for use with a large signal constellation and/or with a large number of antennas.

The calculation of a reduced lattice basis and the use of the reduced basis for MIMO detection has been described in the literature. The following publications may be noted in this regard: U. Fincke and M. Pohst, “Improved methods for calculating vectors of short length in a lattice, including a complexity analysis,” Math. Comput., vol. 44, no. 5, pp. 463-471, May 1985; M. O. Damen, H. El Gamal, and G. Caire, “On maximum-likelihood detection and the search for the closest lattice point,” IEEE Trans. Inform. Theory, vol. 49, no. 10, pp. 2389-2402, October 2003; E. Agrell, T. Eriksson, A. Vardy, and K. Zeger, “Closest point search in lattices,” IEEE Trans. Inform. Theory, vol. 48, no. 8, pp. 2201-2214, August 2002; C. P. Schnorr and M. Euchner, “Lattice basis reduction: Improved practical algorithms and solving subset sum problems,” Math. Programming, vol. 66, no. 2, pp. 181-191, September 1994; D. Wübben, R. Böhnke, V. Kuhn, and K. Kammeyer, “Near-maximum-likelihood detection of MIMO systems using MMSE-based lattice-reduction,” in Proc. IEEE Int. Conf. Commun., Paris, France, Jun. 20-24 2004, vol. 2, pp. 798-802; A. K. Lenstra, H. W. Lenstra, and L. Lovasz, “Factoring polynomials with rational coefficients,” Math. Ann., vol. 261, pp. 515-534, 1982; D. Wübben, R. Böhnke, V. Kuhn, and K. Kammeyer, “MMSE-based lattice-reduction for near-ML detection of MIMO systems,” in Proceedings of the ITG Workshop on Smart Antennas, Mar. 18-19 2004, pp. 106-113.

As was noted above, to make lattice reduction-based MIMO detectors usable in practice good quality soft information should be generated by the lattice reduction based MIMO detector. Prior to this invention this need was not met in a computationally efficient manner.

### SUMMARY OF THE EXEMPLARY EMBODIMENTS

The foregoing and other problems are overcome, and other advantages are realized, in accordance with the non-limiting and exemplary embodiments of this invention.

In accordance exemplary embodiments of this invention a method includes, in response to a MIMO signal received from a channel, computing a change of basis matrix T and a reduced lattice basis matrix HT; forming a list L of points from the matrix HT; and performing MIMO detection for each point in the list L to output a list C of constellation points used to calculate soft bit decisions.

Further in accordance exemplary embodiments of this invention there is provided a computer program product stored in a memory that is operable to perform operations comprising, in response to a MIMO signal received from a channel, computing a change of basis matrix T and a reduced lattice basis matrix HT; forming a list L of points from the matrix HT; and performing MIMO detection for each point in the list L to output a list C of constellation points used to calculate soft bit decisions.

Further still in accordance exemplary embodiments of this invention there is provided a circuit that includes an input for coupling to a MIMO signal received from a channel to compute a change of basis matrix T and a reduced lattice basis matrix HT, to form a list L of points from the matrix HT and to perform MIMO detection for each point in the list L. The circuit further includes an output to output a list C of constellation points to a unit for use in to calculating soft bit decisions.

### BRIEF DESCRIPTION OF THE DRAWINGS

The foregoing and other aspects of the teachings of this invention are made more evident in the following Detailed Description, when read in conjunction with the attached Drawing Figures, wherein:

FIGS. 1-5 are each a graph plotting BER versus SNR, and more specifically,

FIG. 1 is a graph illustrating hard decision BER.

FIG. 2 is a graph illustrating soft decision coded BER for 4×4 QPSK.

FIG. 3 is a graph illustrating soft decision coded BER for 8×8 QPSK.

FIG. 4 is a graph illustrating soft decision coded BER for 4×4 16 QAM.

FIG. 5 is a graph illustrating soft decision coded BER for 8×8 16 QAM.

FIG. 6 is a logic flow diagram that is illustrative of a method, and the operation of a computer program product, in accordance with the exemplary embodiments of this invention.

FIG. 7 is a simplified block diagram of a MIMO system that includes a lattice reduction aided MIMO detector that operates in accordance with the exemplary embodiments of this invention.

### DETAILED DESCRIPTION

The exemplary embodiments of this invention relate to the detection of a MIMO transmission using a reduced lattice basis for the transmitted constellation, where the MIMO detection using lattice reduction provides a low complexity detection technique while maintaining good detection performance.

More specifically, a lattice reduction technique in accordance with exemplary embodiments of this invention calculates a unimodular integer change of a basis matrix T for a channel H such that H*T is nearer to being an orthogonal matrix than H. MIMO detection is then be performed by operating with H*T and T⁻¹x, as opposed to H and x, where x is the transmitted symbol vector. The near orthogonality property of H*T results in a relatively small noise enhancement with linear detection techniques (e.g., Zero Forcing, MMSE), hence good detection performance is maintained. Lattice reduction may also be employed to improve the performance of low complexity non-linear MIMO detectors, such as SIC detectors.

The exemplary embodiments of this invention use the reduced lattice basis to generate soft decisions. The lattice reduction principle and soft decisions generation are closely related. The goal of the reduced lattice basis is to find a basis with short vectors. The goal of the soft decision generation is to find the closest points in the signal constellation that have the opposite bit value compared to the hard decisions. The exemplary embodiments of this invention use the reduced lattice basis to find the constellation points that are close to the hard decision point, and then use the found points to generate the soft decisions.

The following description is made in the context of a non-limiting embodiment, it being realized that other approaches may be used to achieve the same results.

The system model is:

r=Hx+n.

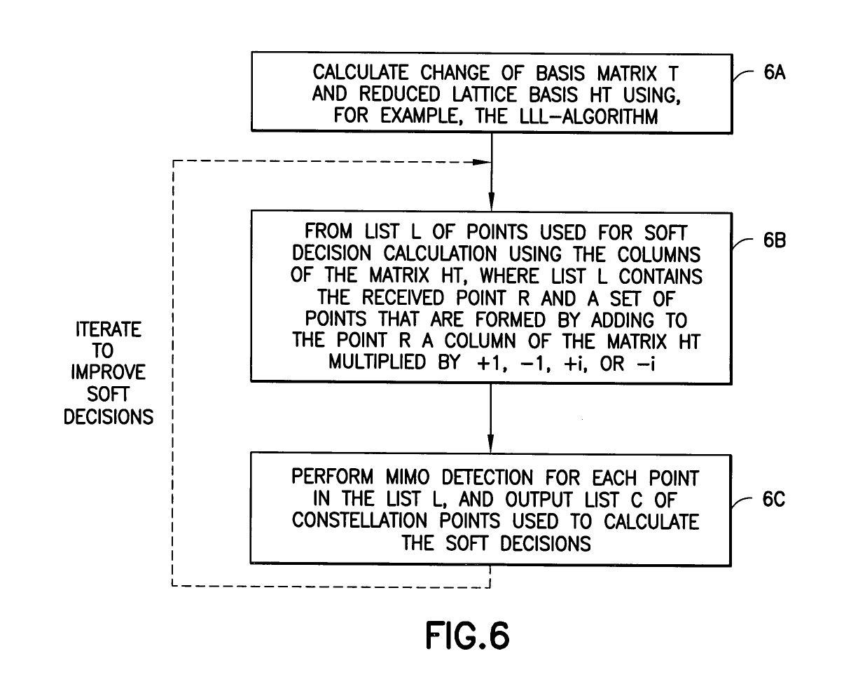

Referring also to the logic flow diagram of FIG. 6, at Block 6A the change of basis matrix T and the reduced lattice basis HT are calculated with, for example, the LLL-algorithm (see A. K. Lenstra, H. W. Lenstra, and L. Lovasz, “Factoring polynomials with rational coefficients,” Math. Ann., vol. 261, pp. 515-534, 1982, incorporated by reference herein). The columns of the matrix HT are short in the sense of lattice reduction.

At Block 6B the list L of points used for soft decision calculation is formed using the columns of the matrix HT. The list L contains the received point r and a set of points that are formed by adding to the point r a column of the matrix HT multiplied by a scaling factor (e.g., +0.8, −0.8, +0.8i, −0.8i, or for slightly less accuracy +1, −1, +i, or −i). Slightly better performance was achieved with the scaling 0.8 factors above. As a result, the size of the list L is one plus four times the number of transmit antennas (1+4*Nₜₓ). The multiplication of the columns of the matrix HT by the scaling factor amounts to attempting to efficiently cover the surroundings of the received point such that the best possible point is found for each bit to calculate the soft decision.

At Block 6C, and after the list L has been generated, a MIMO detection is performed for each point in the list. The detection process may use any suitable MIMO detector, but it is natural (and preferred) to use a lattice reduction-aided detector. The detector outputs a list C of constellation points that are then used to calculate the soft decisions. The soft decision calculation method may be the well known MaxLogMAP method, which retains the best candidate point for each possible bit value and then calculates the soft decision based on the retained candidate points.

It is possible that the list C does not contain a candidate for both possible bit values for each of the bits. In this case a constant value may be used as an approximation for the soft decision. The constant may be a preset value, or it may be based on the other soft decisions, or the distances of the points corresponding to points in the list C from the received point. Similarly, the soft decision outputs can be checked for values that are too large (e.g., checked against a preset constant, against a value derived from the channel matrix H or from the reduced basis matrix HT), in which case the magnitude of the too-large value is replaced by the limiting value against which it is compared (without changing sign).

It should be noted that the list L may be generated by other techniques, so long as the reduced lattice is used to find points that are close to the hard decisions point. For example, the order of operations may be changed such that a hard MIMO detection is first performed for the received point r, and then the columns of HT may be added to the to the hard decision point. Another possibility is to use the hard decision estimate of the transmitted vector x and add suitably multiplied columns of the matrix T to the vector x. Combinations of the methods are also possible to enlarge the size of the list.

A still further modification to the foregoing exemplary embodiments uses an iterative approach.

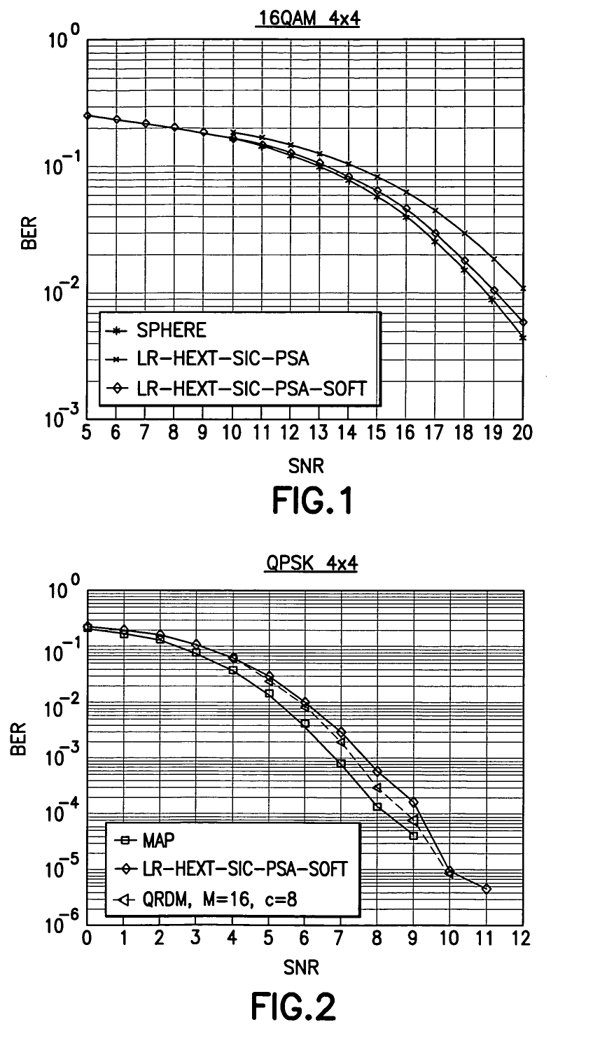

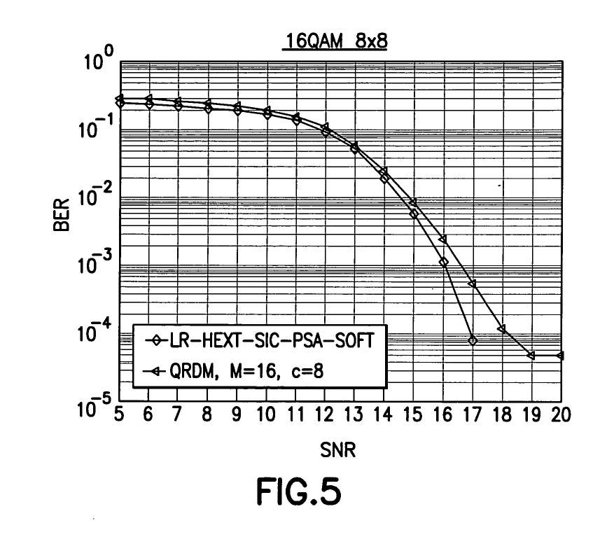

More specifically, the soft decision calculation also improves the hard decision BER of a pure hard decision lattice reduction detection, as can been seen from FIG. 1 which shows the hard decision BER for sphere detection (equivalent to maximum likelihood), hard decision lattice reduction detection (Lattice Reduction with extended channel matrix H using Serial Interference Canceling MIMO Detector with Post Sorting Algorithm, or LR-Hext-SIC-PSA in the FIG. 1 legend) and soft decision lattice reduction (LR-Hext-SIC-PSA-Soft in the legends of FIGS. 1-5, same as above but outputting soft decisions). The soft decision LR method improves the performance of the pure LR hard decision method by approximately 1 dB. Therefore, it can be seen that the soft decision calculation produces an improved hard decision estimate of the transmitted bits. This improved hard decision estimate can then be used to calculate the vector to which the columns of HT or T are added to generate a new list L, which is then used to improve the previously calculated soft decisions. The iteration may be continued until no improvement is achieved for the hard decisions. The iterative nature of this process is indicated generally in FIG. 6 by the dashed line from the output of Block 6C to the input of Block 6B. In other embodiments, the iterative segment of FIG. 6 can be redirected to produce a new list, or can append the new points to the original list L.

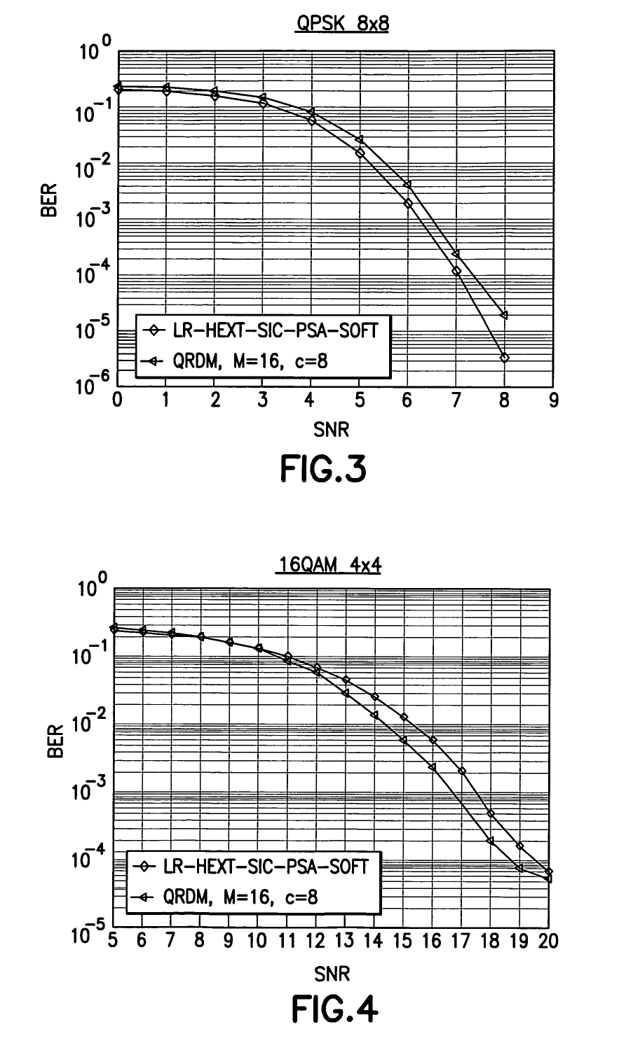

On advantage of the use of the exemplary embodiments of this invention is that good quality soft decision are generated with a method that has only polynomial complexity, dependent on the number of antennas or the transmitted constellation. Note that the overall lattice reduction-aided MIMO detection includes the calculation of the reduced lattice basis, which is the most complex single operation of the detection. The performance is good with large numbers of antennas as shown in FIG. 3 and FIG. 5, which show somewhat better performance than QRD-M detection. Note that the QRD-M detection performance may be improved from these figures with higher complexity (larger M value) and/or by optimizing the value of the constant c for the used constellation and number of antennas. QRD-M (QR-Decomposition with M-search algorithm) is a known technique. Specifically, Q is a unitary matrix (Q^{H}Q=I) and R is a right triangular matrix (all elements below main diagonal are zero), and M is a constant parameter of the algorithm.

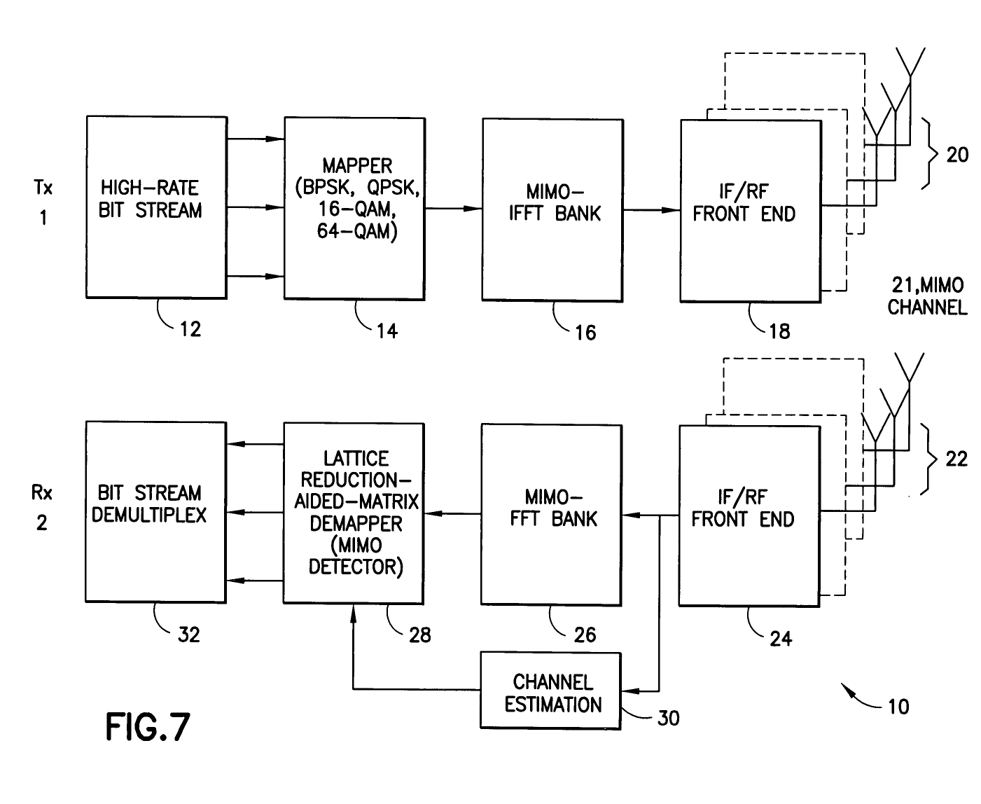

Reference is made to FIG. 7 for illustrating a simplified system model of a MIMO-OFDM system 10 using spatial multiplexing, and represents one suitable technical environment wherein the exemplary embodiments of this invention may be implemented. FIG. 7 is adapted from FIG. 3 of Yuanbin Guo, Dennis McCain, Joseph R. Cavallaro, Andrea Takach, “Rapid Industrial Prototyping and SoC Design of 3G/4G Wireless Systems Using an HLS Methodology”, Eurasip Journal on Embedded Systems, Vol. 2006, Article 1D 14952, pgs. 1-25. In the transmitter (Tx 1) side a high-rate bit stream 12 is applied to a constellation mapper 14 (e.g., BPSK, QPSK, 16-QAM, 64-QAM) and then to MIMO-IFFT bank an RF front-end. Assuming N_{T} transmit and N_{R} receive antennas 20 and 22, respectively, at the pth transmit antenna the multiple bit streams 12 are modulated by the constellation mapper 14 to some QPSK or QAM symbols. For the case of the illustrated OFDM system 10, after insertion of a cyclic prefix and multipath propagation through the MIMO fading channel 21, the signal is received at the receiver (Rx 2) and applied to an IF/RF front end 24, and is then provided to a MIMO-FFT bank 26 where an N_{F}-point FFT is operated on the received signal at the qth receive antennas to demodulate the frequency-domain symbols. Shown in this example is a matrix demapper 28, which operates in conjunction with a channel estimation block 30. The demapped signal is then applied to a bit stream demultiplexer 32. The matrix demapper is constructed and operated in accordance with the exemplary embodiments of this invention to provide the lattice reduction-aided MIMO detector that is used for generating the soft decisions, as was discussed above.

Consider a non-limiting example for a system with three transmit and three receive antennas. The transmitted data is represented as x such that

$$x = [ \begin{matrix}{x}_{1} \\ {x}_{2} \\ {x}_{3}\end{matrix} ] ;$$

where the points xᵢ belong to for example QPSK constellation.

The channel H is then a 3×3 matrix:

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

The noise forms a 3×1 vector:

$$n = [ \begin{matrix}{n}_{1} \\ {n}_{2} \\ {n}_{3}\end{matrix} ]$$

The received signal r after the channel H effect and noise n is added is

$$r = [ \begin{matrix}{r}_{1} \\ {r}_{2} \\ {r}_{3}\end{matrix} ] = Hx + n$$

The receiver calculates the change of basis matrix T and the reduced lattice basis HT. This can be done with the LLL-algorithm as noted above. The LLL-algorithm can be implemented to return the matrix T and a QR-decomposition of the reduced lattice basis matrix HT, ie. QR=HT, where Q is a unitary matrix and R is a right triangular matrix. The system is then modeled as:

r=HTT⁻¹x+n= H̅ x̅+n;

i.e. as the channel was HT and T⁻¹x was transmitted, H̅=HT and x̅=T⁻¹x.

Next the list L is generated. The list L is formed, for example, by taking the received point r and adding to it each column of the matrix HT multiplied by some scaling constants, for example +1, −1, +i, −i.

Denote the columns of HT by htᵢ, that is ht₁ is the first column of HT and so on. The list L then contains 13 (=1+4*3) points:

L={r, r+ht₁, r−ht₁, r+i*ht₁, r−i*ht₁, r+ht₂, r−ht₂, r+i*ht₂, r−i*ht₂, r+ht₃, r−ht₃, r+i*ht₃, r−i*ht₃}

After the list L is generated, MIMO detection is performed for each point in the list L, with for example a Serial Interference Cancelling (SIC) MIMO detector, known in the art.

For SIC detection, each point in the list L is multiplied by Q^{H}, using the Q matrix of the QR decomposition of HT. For the original received value r the result is:

\tilde{r}=Q^{H}r=Q^{H}HTT⁻¹x+Q^{H}n=Q^{H}QRT⁻¹x+Q^{H}n=RT⁻¹x+ n̅=R x̅+ n̅

The SIC detection proceeds by operating on \tilde{r}

All the values of R are zero below the main diagonal, hence an estimate for the last coordinate of x̅ can be directly obtained from \tilde{r}:

$$\tilde{r} = R \overline{x} + \overline{n} = [ \begin{matrix}{r}_{11} & {r}_{12} & {r}_{13} \\ 0 & {r}_{22} & {r}_{23} \\ 0 & 0 & {r}_{33}\end{matrix} ] [ \begin{matrix} {\overline{x}}_{1} \\ {\overline{x}}_{2} \\ {\overline{x}}_{3}\end{matrix} ] + [ \begin{matrix} {\overline{n}}_{1} \\ {\overline{n}}_{2} \\ {\overline{n}}_{3}\end{matrix} ]$$

The last row of the matrix equation is \tilde{r}₃=r₃₃ x̅₃+ n̅₃, hence an estimate \hat{x}₃ for the value of x̅₃ can easily be solved by

$${\hat{x}}_{3} = \frac{{\tilde{r}}_{3}}{{r}_{33}} = {\overline{x}}_{3} + \frac{ {\overline{n}}_{3}}{{r}_{33}} .$$

Next the estimate \hat{x}₃ is quantized to a legal value in the lattice T⁻¹x, i.e.

$${\hat{\underline{x}}}_{3} = Quantize \{ {\hat{x}}_{3} \} .$$

Now the remaining coordinates of x̅ can be estimated by subtracting the previously estimated coordinates from the remaining matrix equations. The second row of the above matrix gives an equation \tilde{r}₂=r₂₂ x̅₂+r₂₃ x̅₃+ n̅₂. Previously an estimate for the value of x̅₃ was obtained, hence an estimate \hat{x}₂ for the value of x̅₂ can be obtained by subtracting the influence of x̅₃ (assuming we made a correct decision in the quantization of \hat{x}₃, in which case x̅₃=\hat{x}₃) from the above equation and dividing the result by r₂₂. Mathematically,

$${\hat{x}}_{2} = \frac{{\tilde{r}}_{2} - {r}_{23} {\hat{\underline{x}}}_{3}}{{r}_{22}} = {\overline{x}}_{2} + \frac{ {\overline{n}}_{2}}{{r}_{22}} .$$

Then, the estimate of \hat{x}₂ is quantized to a legal value in the lattice T⁻¹x, i.e. \hat{x}₂=Quantize{\hat{x}₂}.

Now the receiver has estimates for the values of x̅₂ and x̅₃, so it can similarly find an estimate \hat{x}₁ for the value of x̅₁. The first row of the above matrix equation is \tilde{r}₁=r₁₁ x̅₁+r₁₂ x̅₂+r₁₃ x̅₃+ n̅₁. The influence of both x̅₂ and x̅₃ is removed and the result is divided by r₁₁ to obtain the estimate \hat{x}₁ for the value of x̅₁:

$${\hat{x}}_{1} = \frac{{\tilde{r}}_{1} - {r}_{12} {\hat{\underline{x}}}_{2} - {r}_{13} {\hat{\underline{x}}}_{3}}{{r}_{11}} = {\overline{x}}_{1} + \frac{ {\overline{n}}_{1}}{{r}_{11}} .$$

Finally the estimate of \hat{x}₁ is quantized to a legal value in the lattice T⁻¹x, i.e. \hat{x}₁=Quantize{\hat{x}₁}.

Now we have an estimate \hat{x} for the full vector x̅=T⁻¹x and the estimate \tilde{x} for the constellation point x is obtained my multiplying \hat{x} by T, \tilde{x}=T\hat{x}=TT⁻¹x=x, (assuming correct quantization decision in the SIC process).

The above example used the received point r as the input to the SIC detector, hence we now have a hard decision as the output of the SIC detector. The next step in the soft decision generation process is to repeat the above described SIC detector for all the remaining points in the list L. After this has been done we have a list C that contains the hard decision and a list of additional points used to calculate the soft decisions. C={c₁, c₂, c₃, c₄, c₅, c₆, c₇, c₈, c₉, c₁₀, c₁₁, c₁₂, c₁₃}, where c₁ is the hard decision point and c₂ to c₁₃ are the points generated by the SIC detector from the rest of the points in the list L.

The final step of the detector is to calculate the soft decisions. In this example there were three antennas with a QPSK constellation, i.e. a total of six bits was transmitted, (6=3 (antennas)*2 (bits per antenna for QPSK)).

The first step in generating the MaxLogMAP soft decisions is to calculate the squared distances between the received point r and the points obtained by applying the channel effect to the points in the list C. This yields a list D={d₁, d₂, d₃, d₄, d₅, d₆, d₇, d₈, d₉, d₁₀, d₁₁, d₁₂, d₁₃} of squared distances, where dᵢ=∥r−Hcᵢ∥².

Now the MaxLogMAP soft decisions are calculated by finding, for each transmitted bit, the smallest distance for which the bit value is 0 and the distance for which the bit value is 1. For example, for the first bit the smallest distance with the first bit value 0 could be d₃ and the smallest distance with first bit value 1 could be d₇. Then the soft decision for the first bit is

$$\frac{{d}_{3} - {d}_{7}}{{σ}^{2}} .$$

The division by σ² takes into account the effect of noise variance on the soft decision reliability. This example assumes that negative soft decisions imply that a zero bit was transmitted. The distance search is then repeated similarly for all the transmitted bits to generate the rest of the soft decisions.

Two possible conditions can arise from the limited size of the list L. First there might not be a distance in the list D for both the 0 and 1 bit values for some transmitted bit. In this case the soft decision can be approximated by the techniques described above. Second, the magnitude of some of the soft decisions might be quite large. This results from a case when either the 0 or the 1 bit value distance was calculated from a point that was quite far from the received point. In this case it is possible (or even likely) that there exists a point with that particular bit value that is closer to the received point than the point corresponding to the distance in the list D. In this case it is preferable to limit the soft decision magnitude to some value to prevent too large confidence being given to that bit, as noted above.

In general, the various embodiments of the Rx 2 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Note that in some embodiments, where the Tx 1 is embodied in a mobile device, the Rx 2 may be embodied in a base station or Node B-type of fixed network element.

The exemplary embodiments of this invention may be implemented by computer software stored in a memory device of the Rx 2 and executable by a data processor of the Rx 2 (such as a high speed digital signal processor), or the exemplary embodiments may be implemented by hardware, or by a combination of software and hardware.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example, the logic flow diagram of FIG. 6 may be viewed as a sequence of logical operations, method steps or computer program code modules, or it may be viewed as an interconnected set of hardware function blocks implemented as, for example, circuitry embodied in an integrated circuit.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims. As but some examples, the use of other similar or equivalent algorithms (i.e., other than the LLL-algorithm) for calculating the change of basis matrix T and the reduced lattice basis HT may be attempted by those skilled in the art. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method comprising:
in response to a MIMO signal received from a channel, computing a change of basis matrix T and a reduced lattice basis matrix HT;
forming a list L of points from the matrix HT; and
performing MIMO detection for each point in the list L to output a list C of constellation points used to calculate soft bit decisions.

2. The method of claim 1, where soft decision calculation uses a MaxLogMAP method that retains a best candidate point for each possible bit value and calculates the soft decision based on the retained candidate points.

3. The method of claim 1, where a size of the list L is one plus four times a number of transmit antennas (1+4*Nₜₓ).

4. The method of claim 1, where for a case that the list C does not contain a candidate for both possible bit values for each of the bits, further comprising approximating the soft decision using a constant.

5. The method of claim 4, where the constant has one of a preset value, or a value based on other soft decisions, or a value based on distances of the points corresponding to points in the list C from a received point.

6. The method of claim 1, where for a case that a soft decision magnitude exceeds a limiting value, further comprising approximating the soft decision magnitude using the limiting value.

7. The method of claim 1, where the list L comprises a received point r and a set of points that are formed by adding to the point r a column of the matrix HT multiplied by +1, −1, +i, or −i.

8. The method of claim 1, where the list L comprises a received point r and is formed by performing hard MIMO detection for the received point r, and adding the columns of HT to the to the hard decision point.

9. The method of claim 1, where the list L comprises a received point r and is formed by using a hard decision estimate of transmitted vector x and adding multiplied columns of the matrix T to the vector x.

10. The method of claim 1, further comprising using iterations where a soft decision calculation produces an improved hard decision estimate of the transmitted bits, where the improved hard decision estimate is used to calculate a vector to which the columns of HT or T are added to generate a new list L, which is used to improve previously calculated soft decisions.

11. A computer program product stored in a memory operable to perform operations comprising:
in response to a MIMO signal received from a channel, computing a change of basis matrix T and a reduced lattice basis matrix HT;
forming a list L of points from the matrix HT; and
performing MIMO detection for each point in the list L to output a list C of constellation points used to calculate soft bit decisions.

12. The computer program product of claim 11, where soft decision calculation uses a MaxLogMAP method that retains a best candidate point for each possible bit value and calculates the soft decision based on the retained candidate points.

13. The computer program product of claim 11, where a size of the list L is one plus four times a number of transmit antennas (1+4*Nₜₓ).

14. The computer program product of claim 11, where for a case that the list C does not contain a candidate for both possible bit values for each of the bits, further comprising approximating the soft decision using a constant.

15. The computer program product of claim 14, where the constant has one of a preset value, or a value based on other soft decisions, or a value based on distances of the points corresponding to points in the list C from a received point.

16. The computer program product of claim 11, where for a case that a soft decision magnitude exceeds a limiting value, further comprising approximating the soft decision magnitude using the limiting value.

17. The computer program product of claim 11, where the list L comprises a received point r and a set of points that are formed by adding to the point r a column of the matrix HT multiplied by +1, −1, +i, or −i.

18. The computer program product of claim 11, where the list L comprises a received point r and is formed by performing hard MIMO detection for the received point r, and adding the columns of HT to the to the hard decision point.

19. The computer program product of claim 11, where the list L comprises a received point r and is formed by using a hard decision estimate of transmitted vector x and adding multiplied columns of the matrix T to the vector x.

20. The computer program product of claim 11, further comprising using iterations where a soft decision calculation produces an improved hard decision estimate of the transmitted bits, where the improved hard decision estimate is used to calculate a vector to which the columns of HT or T are added to generate a new list L, which is used to improve previously calculated soft decisions.

21. A circuit comprising an input for coupling to a MIMO signal received from a channel to compute a change of basis matrix T and a reduced lattice basis matrix HT, to form a list L of points from the matrix HT and to perform MIMO detection for each point in the list L, said circuit further comprising an output to output a list C of constellation points to a unit for use in calculating soft bit decisions.

22. The circuit of claim 21, where the soft decision calculation unit comprises a MaxLogMAP unit that retains a best candidate point for each possible bit value and calculates the soft decision based on the retained candidate points.

23. The circuit of claim 21, where a size of the list L is one plus four times a number of transmit antennas (1+4*Nₜₓ).

24. The circuit of claim 21, where for a case that the list C does not contain a candidate for both possible bit values for each of the bits, said circuit approximates the soft decision using a constant.

25. The circuit of claim 24, where the constant has one of a preset value, or a value based on other soft decisions, or a value based on distances of the points corresponding to points in the list C from a received point.

26. The circuit of claim 21, where for a case that a soft decision magnitude exceeds a limiting value, said circuit approximates the soft decision magnitude using the limiting value.

27. The circuit of claim 21, where the list L comprises a received point r and a set of points that are formed by adding to the point r a column of the matrix HT multiplied by +1, −1, +i, or −i.

28. The circuit of claim 21, where the list L comprises a received point r and is formed by performing hard MIMO detection for the received point r, and adding the columns of HT to the to the hard decision point.

29. The circuit of claim 21, where the list L comprises a received point r and is formed by using a hard decision estimate of transmitted vector x and adding multiplied columns of the matrix T to the vector x.

30. The circuit of claim 21, operable to iterate such that a soft decision calculation produces an improved hard decision estimate of the transmitted bits, where the improved hard decision estimate is used to calculate a vector to which the columns of HT or T are added to generate a new list L, which is used to improve previously calculated soft decisions.

31. The circuit of claim 21, embodied in an integrated circuit.

32. The circuit of claim 21, embodied in a mobile receiver.

33. The circuit of claim 21, embodied in a mobile OFDM receiver.
